(19) United States
(12) Patent Application Publication
(10) Pub. No.: US 2025/0353438 A1
(43) Pub. Date: Nov. 20, 2025

(54) CONSOLE BOX

(71) Applicant: KOJIMA INDUSTRIES CORPORATION, Toyota-shi (JP)

(72) Inventor: Yu TORII, Toyota-shi (JP)

(73) Assignee: KOJIMA INDUSTRIES CORPORATION, Toyota-shi (JP)

(21) Appl. No.: 19/201,051

(22) Filed: May 7, 2025

(30) Foreign Application Priority Data
May 14, 2024 (JP) 2024-078500

(51) Int. Cl. B60R 7/04

(52) U.S. Cl. CPC B60R 7/04

(57) ABSTRACT

A console box may include a main body having an opening, and a lid connected to the main body via a left hinge device and a right hinge device and configured to open and close the opening in a dual swing-mode. The lid includes a left hinge device actuating mechanism for actuating the left hinge device, a right hinge device actuating mechanism for actuating the right hinge device, a left release device linked to the left hinge device actuating mechanism and configured to release the left hinge device actuating mechanism by pressing, a right release device linked to the right hinge device actuating mechanism and configured to release the right hinge device actuating mechanism by pressing, and a control member configured to selectively control a movement of each of the right and left release devices.

### CROSS-REFERENCE TO RELATED APPLICATIONS

This application claims priority to a Japanese Patent Application serial number 2024-078500 filed May 14, 2024, which is hereby incorporated herein by reference in its entirety for all purposes.

### BACKGROUND

The present disclosure relates to a vehicular console box. More specifically, the present disclosure relates to a vehicular console box including a console box main body having a console opening, and a console lid rotatably connected to the console box main body via a right hinge device (right hinge axes) and a left hinge device (left hinge axes) such that the console lid is configured to open and close the console opening in a dual swing-mode.

A known vehicular console box including a console box main body having a console opening and a console lid is taught, for example, by Japanese Laid-Open Patent Publication No. 9-317310 (JP9-317310A). In such console box, the console lid is connected to the console box main body via a right hinge device (right hinge axes) and a left hinge device (left hinge axes) and is configured to open and close the console opening in a dual swing-mode. That is, the console lid is configured to be selectively swung or rotated in the rightward or leftward rotation direction about the right hinge device (the right hinge axes) or the left hinge device (the left hinge axes).

Further, the console lid includes a right hinge device actuating mechanism for actuating the right hinge device and a left hinge device actuating mechanism for actuating the left hinge device. Further, the lid includes right and left knobs (release members) and a single slide member, which may be referred to as a release device. The slide member is positioned between the right and left knobs. Further, the slide member is configured to move or slide to the right or the left by manipulating or pressing the right knob or the left knob. The right and left knobs are linked to the right hinge device actuating mechanism and the left hinge device actuating mechanism via the slide member. When one of the right and left knobs is pressed to slide the slide member, one of the right and left hinge device actuating mechanisms is released. As a result, one of the right and left hinge devices is de-actuated. Thus, the console lid is allowed to be freely rotated about the other of the right and left hinge devices in order to open the console opening. Further, the console lid includes a check lever. The check lever is configured to move in conjunction with opening and closing operation of the console lid, thereby controlling a movement of the slide member.

### SUMMARY

In one aspect of the present disclosure, a console box may include a main body having an opening, and a lid connected to the main body via a left hinge device and a right hinge device and configured to open and close the opening in a dual swing-mode. The lid includes a left hinge device actuating mechanism for actuating the left hinge device, a right hinge device actuating mechanism for actuating the right hinge device, a left release device linked to the left hinge device actuating mechanism and configured to release the left hinge device actuating mechanism by pressing, a right release device linked to the right hinge device actuating mechanism and configured to release the right hinge device actuating mechanism by pressing, and a control member configured to selectively control a movement of each of the right and left release devices. The right and left release devices are disposed on the lid with a space therebetween. The right and left release devices are configured such that when one of the right and left release devices is pressed, one of the right and left release devices is positioned close to the other of the right and left release devices. The control member is configured such that in the condition in which the lid is closed, the control member moves to a position in which the control member allows the right and left release devices to move relative to each other. The control member is configured such that in a condition in which one of the right and left release devices is pressed and in which the lid is opened, the control member moves to a position in which the control member engages one of the right and left release devices to prevent the right and left release devices from moving relative to each other.

According to the aspect, for example, when one of the right and left release devices is pressed, one of the right and left release devices is positioned close to the other of the right and left release devices. Therefore, in a condition in which one of the right and left release devices is pressed, the other of the right and left release devices is prevented from being pressed. That is, the right and left release devices are prevented from being simultaneously pressed. As a result, the right and left hinge device actuating mechanisms are prevented from being simultaneously released. In addition, when one of the right and left release device is pressed, one of the right and left release devices does not interfere with the other of the right and left release devices that is not pressed. Therefore, each of the right and left release devices can be smoothly pressed. Further, in the condition in which one of the right and left hinge device actuating mechanisms is released by pressing one of the right and left release devices and in which the lid is opened, one of the right and left release devices is prevented from turning back due to engagement with the control member. Therefore, even when the pressing operation of one of the right and left release devices is released, the condition in which one of the right and left hinge device actuating mechanisms is released is automatically kept. Further, each of the right and left release devices is simplified in structure. Therefore, the number of parts can substantially be reduced.

Other objects, features and advantage of the present disclosure will be readily understood after reading the following detailed description together with the accompanying drawings and the claims.

### BRIEF DESCRIPTION OF THE DRAWINGS

FIG. 1 is a perspective view of a vehicular console box according to a representative embodiment;

FIG. 2 is an exploded perspective view of the console box of FIG. 1;

FIG. 3 is a bottom perspective view of the console lid of FIG. 1, in which an inner member is omitted; and

FIG. 4 is a cross-sectional view of the console box of FIG. 1 taken along line IV-IV in FIG. 1;

FIG. 5 is a cross-sectional view of the console box of FIG. 1 taken along line V-V in FIG. 1;

FIG. 6 is a cross-sectional view of the console box of FIG. 1 taken along line VI-VI in FIG. 1

FIG. 7 is a cross-sectional view of the console box of FIG. 1 taken along line VII-VII in FIG. 1;

FIG. 8 is a cross-sectional view similar to FIG. 4, in which a left knob is manipulated or pressed;

FIG. 9 is a cross-sectional view similar to FIG. 5, in which the left knob is manipulated or pressed; and

FIG. 10 is a cross-sectional view similar to FIG. 6, in which the console lid is slightly rotated with the left knob manipulated or pressed.

### DETAILED DESCRIPTION

As previously described, a known console box disclosed in JP9-317310A is configured to open and close the console opening in a dual swing-mode—the console lid is configured to be selectively swung or rotated in the rightward or leftward rotation direction about the right hinge device (the right hinge axes) or the left hinge device (the left hinge axes). However, in such known console box, the release device (the right and left knobs and the slide member) is complicated in structure. Thus, there is a need in the art for an improved vehicular console box.

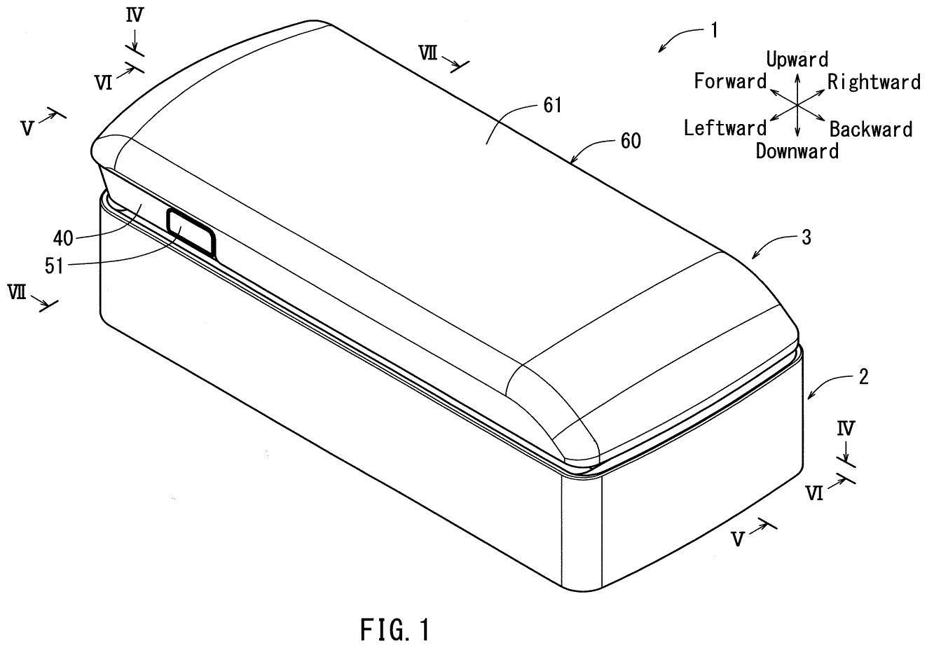

A representative embodiment will now be described in detail with reference to FIGS. 1 to 10.

The embodiment is directed to a vehicular console box 1 configured to be disposed on a vehicle (not shown) such as an automobile. Further, for purposes of clarity and further explanation, forward, backward, rightward, leftward, upward and downward directions as shown and defined in FIG. 1 will be used and relied on to describe the figures. However, such directions may substantially correspond to forward, backward, rightward, leftward, upward and downward directions of the vehicle.

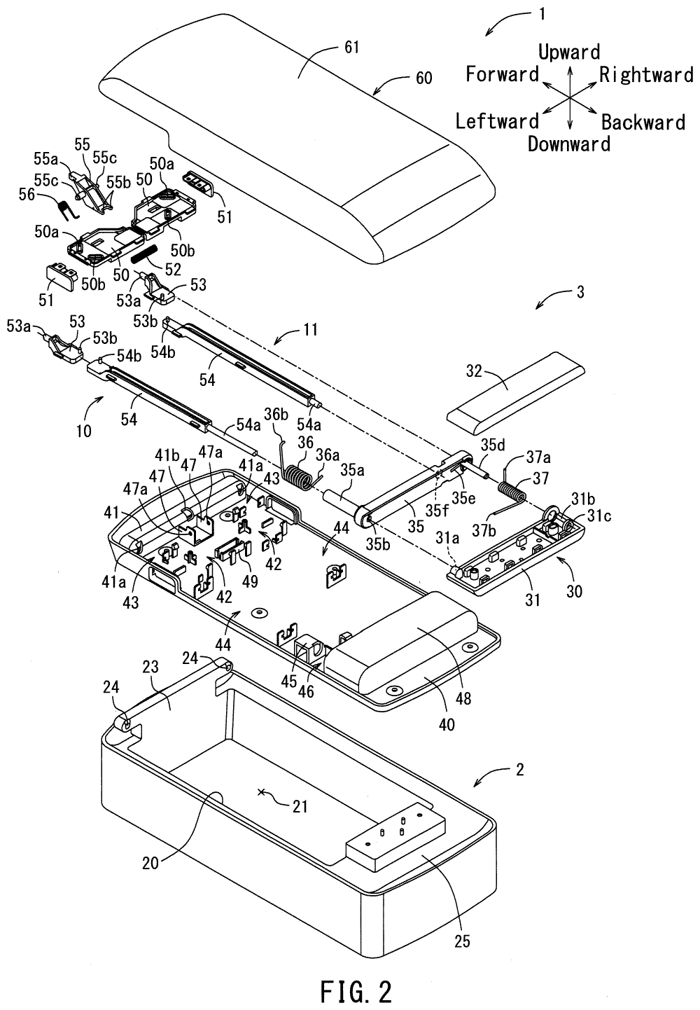

As shown in FIG. 1, the console box 1 includes a console box main body 2 (which may simply referred to as a main body 2) and a console lid 3 (which may simply referred to as a lid 3). As shown in FIG. 2, the main body 2 has a rectangular parallelepiped box-shaped member. In particular, the main body 2 has a rectangular opening 20 that allows access to the inside 21 thereof. Further, the main body 2 includes right and left pin insertion holes 24, 24 formed in upper right and left end portions, respectively, of a front wall 23 thereof.

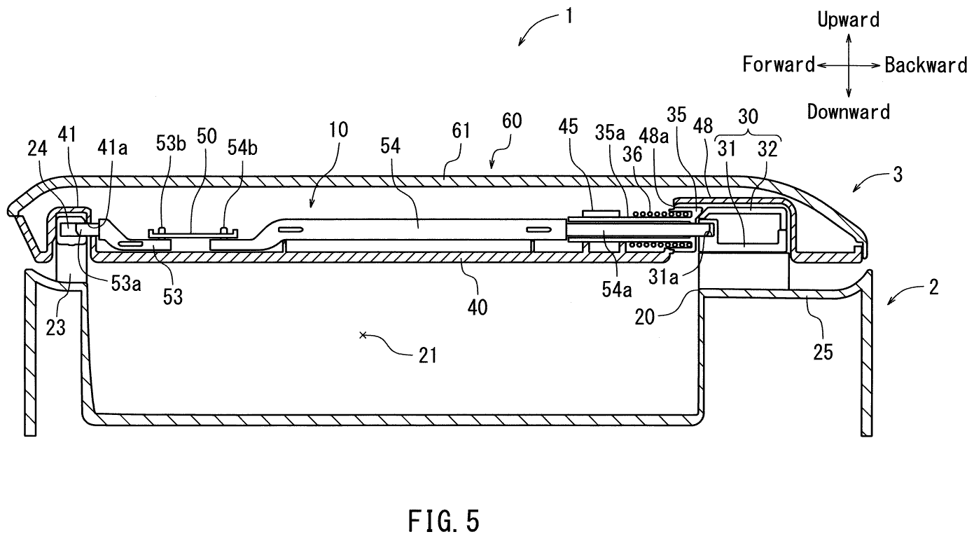

As shown in FIG. 5, the main body 2 also includes a hinge base 30 connected to an upper surface of a rear wall 25 thereof. The hinge base 30 includes a lower hinge cover 31 and an upper hinge cover 32 fitted on the lower hinge cover 31. As shown in FIG. 2, the lower hinge cover 31 includes a (left) pin insertion hole 31a formed in a left end portion thereof.

As shown in FIG. 2, the lower hinge cover 31 includes a spring attachment portion 31b formed in a right end portion thereof. The lower hinge cover 31 includes a right torsion spring 37 attached to the spring attachment portion 31b. Further, the lower hinge cover 31 includes a bearing portion 31c formed in the right end portion thereof. The bearing portion 31c is positioned behind and adjacent to the spring attachment portion 31b in a front-back direction.

As shown in FIGS. 2 and 5, the main body 2 includes a link arm 35 positioned in front of the hinge base 30. The link arm 35 includes a cylindrical spring attachment member 35a formed in a left end portion thereof and projecting forward. The link arm 35 includes a left torsion spring 36 journaled on the spring attachment portion 35a. Further, the link arm 35 includes a through hole 35b formed in the left end portion thereof and axially aligned with the spring attachment member 35a in the front-back direction.

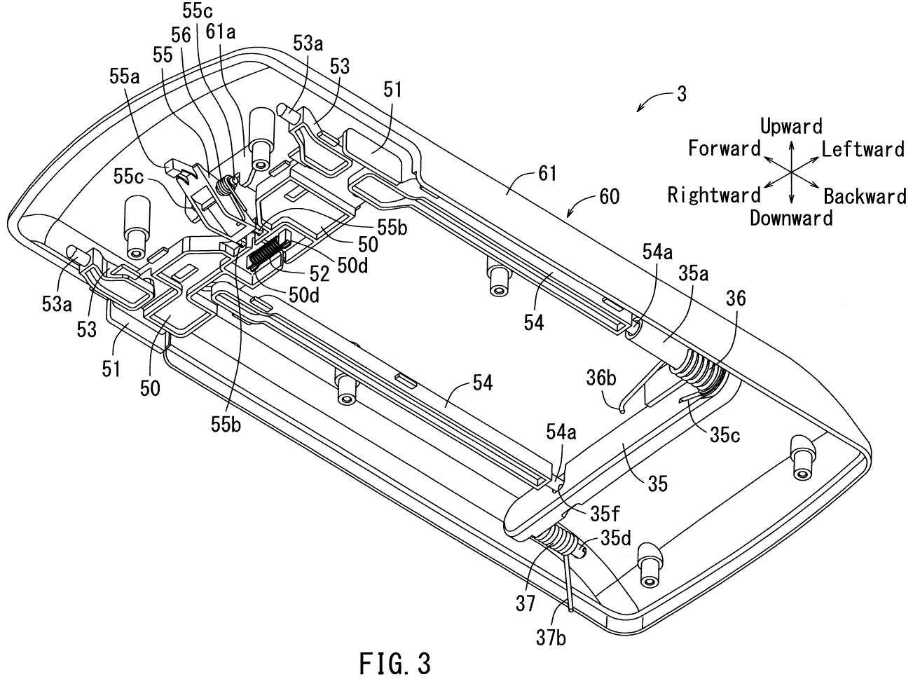

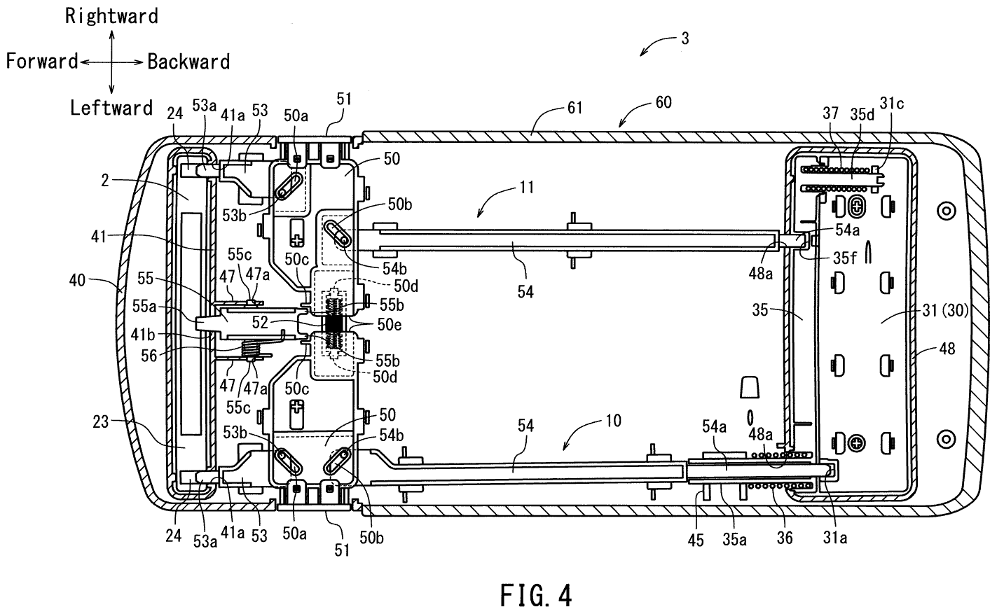

As shown in FIG. 3, the link arm 35 includes a spring engagement groove 35c formed in a front surface of the left end portion thereof. One end portion 36a (FIG. 2) of the left torsion spring 36 is fitted in the spring engagement groove 35c. As shown in FIG. 2, the link arm 35 includes a hinge shaft (right hinge axis) 35d formed in a right end portion thereof and projecting backward. As shown in FIG. 4, the hinge shaft 35d is rotatably supported by the bearing portion 31c formed in the lower hinge cover 31. Further, the link arm 35 includes a spring engagement groove 35e formed in a rear surface of the right end portion thereof. The right torsion spring 37 is journaled on the hinge shaft 35d with one end portion 37a thereof (FIG. 2) fitted in the spring engagement groove 35e. Further, the other end portion 37b of the right torsion spring 37 engages a spring engagement portion (not shown) formed in the lower hinge cover 31 while the right torsion spring 37 is compressed. Thus, the link arm 35 is biased in a rightward rotation direction relative to the lower hinge cover 31 by the right torsion spring 37. Further, as shown in FIG. 3, the link arm 35 includes an engagement pin insertion hole 35f formed in a portion adjacent to the right end portion thereof.

As shown in FIGS. 2 and 5, the lid 3 includes a rectangular dish-shaped lid inner member 40 and a lid outer member 60 configured to be fitted on the lid inner member 40. The lid inner member 40 is integrally formed by integral molding of a hard synthetic resin. As shown in FIGS. 2, 3 and 4, the lid inner member 40 includes right and left retainers 50, right and left knobs 51, right and left front link elements 53, right and left rear elongated link elements (rods) 54, and a control member 55 disposed thereon. Further, the lid inner member 40 includes a front wall 41. The front wall 41 includes right and left through holes 41a formed in right and left end portions thereof, and a central through hole 41b formed in a central portion thereof.

As shown in FIG. 4, each of the right and left retainers 50 is integrally connected to each of the right and left knobs 51. For purposes of clarity and further explanation, the right retainer 50 and the right knob 51 may be referred to herein as a right release device while the left retainer 50 and the left knob 51 may be referred to herein as a left release device. The right and left retainers 50 (the right and left knobs 51) are laterally slidably attached to right and left sides of a front portion of the lid inner member 40 via right and left transverse attachment portions 42 (FIG. 2) formed on the lid inner member 40. Further, the right and left retainers 50 are positioned with a space therebetween and are normally biased laterally outward, i.e., in a direction away from each other, by a compression spring 52. As shown in FIG. 3, the compression spring 52 is held between spring retainer projections 50d formed on the right and left retainers 50, thereby biasing the right and left retainers 50 laterally outward.

As shown in FIG. 4, the left retainer 50 includes a front elongated slot 50a and a rear elongated slot 50b formed therein. The front elongated slot 50a extends from left to right obliquely forward. To the contrary, the rear elongated slot 50b extends from left to right obliquely backward. Further, the left retainer 50 includes an engagement strip 50c formed in an inner (right) end portion and projecting forward. The left retainer 50 includes an (inner) end surface 50e.

As shown in FIG. 4, the left front link element 53 is longitudinally slidably attached to the left side of the front portion of the lid inner member 40 via a left front attachment portion 43 (FIG. 2). The left front link element 53 includes a hinge pin (left hinge axis) 53a formed in a front end thereof and projecting forward. The hinge pin 53a is inserted into the left through hole 41a of the lid inner member 40 while projecting forward through the left through hole 41a. Further, the hinge pin 53a is configured to be removably inserted into the left pin insertion hole 24 of the main body 2. In addition, the left front link element 53 includes a linking pin 53b formed in a rear end thereof and projecting upward. The linking pin 53b movably engages the front elongated slot 50a of the left retainer 50.

As shown in FIG. 4, the left rear elongated link element 54 is longitudinally slidably attached to a rear portion of the lid inner member 40 via a left rear attachment portion 44 (FIG. 2). The left rear elongated link element 54 includes a hinge pin (left hinge axis) 54a formed in a rear end thereof and projecting backward. The hinge pin 54a is configured to be removably inserted into the pin insertion hole 31a of the lower hinge cover 31 through the spring attachment member 35a and the through hole 35b of the link arm 35. Further, the lid inner member 40 includes a bearing member 45 (FIG. 2) formed thereon. The bearing member 45 is configured to support the spring attachment portion 35a of the link arm 35. In addition, the lid inner member 40 includes a spring attachment portion 46 (FIG. 2) formed thereon and positioned adjacent to the bearing member 45. The spring attachment portion 46 is configured such that the left torsion spring 36 journaled on the spring attachment portion 35a is fitted therein. Further, the lid inner member 40 is configured such that the other end portion 36b of the left torsion spring 36 is hooked on a spring engagement portion (not shown) formed therein. Further, the left rear link element 54 includes a linking pin 54b formed in a front end thereof and projecting upward. The linking pin 54b movably engages the rear elongated slot 50b of the left retainer 50. Further, the linking pin 54b and the rear elongated slot 50b functions as a left cam mechanism with the linking pin 53b and the front elongated slot 50a.

As shown in FIG. 4, the right retainer 50 includes a front elongated slot 50a and a rear elongated slot 50b formed therein. The front elongated slot 50a extends from right to left obliquely forward. To the contrary, the rear elongated slot 50b is displaced inward (leftward) relative to the front elongated slot 50a and extends from right to left obliquely backward. Further, the right retainer 50 includes an engagement strip 50c formed in an inner (left) end portion and projecting forward. The right retainer 50 includes an (inner) end surface 50e.

As shown in FIG. 4, the right front link element 53 is longitudinally slidably attached to the right side of the front portion of the lid inner member 40 via a right front attachment portion 43 (FIG. 2). The right front link element 53 includes a hinge pin (right hinge axis) 53a formed in a front end thereof and projecting forward. The hinge pin 53a is inserted into the right through hole 41a of the lid inner member 40 while projecting forward through the left through hole 41a. Further, the hinge pin 53a is configured to be removably inserted into the right pin insertion hole 24 of the main body 2. In addition, the right front link element 53 includes a linking pin 53b formed in a rear end thereof and projecting upward. The linking pin 53b movably engages the front elongated slot 50a of the right retainer 50.

As shown in FIG. 4, the right rear elongated link element 54 is longitudinally slidably attached to a rear portion of the lid inner member 40 via a right rear attachment portion 44 (FIG. 2). The right rear elongated link element 54 includes an engagement pin 54a formed in a rear end thereof and projecting backward. The engagement pin 54a is configured to be inserted into the engagement pin insertion hole 35f of the link arm 35. Further, the right rear link element 54 includes a linking pin 54b formed in a front end thereof and projecting upward. The linking pin 54b movably engages the rear elongated slot 50b of the right retainer 50. Further, the linking pin 54b and the rear elongated slot 50b functions as a right cam mechanism with the linking pin 53b and the front elongated slot 50a.

As shown in FIGS. 2 and 4, the control member 55 is attached to the center of the front portion of the lid inner member 40 via a pair of (right and left) elastically deformable bearing strips 47 formed on the lid inner member 40 and having shaft insertion holes 47a. In particular, the bearing strips 47 are positioned adjacent to the central through hole 41b of the lid inner member 40. The control member 55 includes right and left rotation shafts 55c formed therein. The control member 55 is positioned between the right and left bearing strips 47 with the rotation shafts 55c inserted into the shaft insertion holes 47a of the bearing strips 47. Thus, the control member 55 is rotatably attached to the lid inner member 40. Further, the bearing strips 47 are fixed to the lid inner member 40 while being slightly flexed in a direction away from each other.

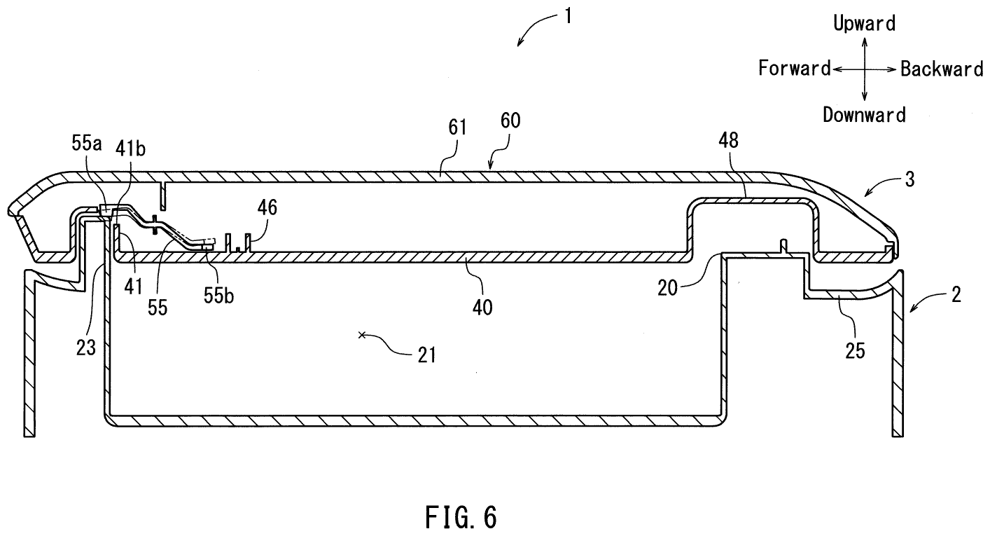

As shown in FIGS. 2 and 4, the control member 55 includes a contact strip 55a formed in a front portion thereof, and a pair of (right and left) engagement projections 55b formed in a rear portion thereof. The control member 55 is attached to the lid inner member 40 such that the contact strip 55a projects outward through the central through hole 41b of the lid inner member 40. Further, as shown in FIGS. 2 to 4, a torsion spring 56 is disposed between the control member 55 and one of the bearing strips 47. As shown by broken line in FIG. 6, the torsion spring 56 is arranged to rotate (bias) the control member 55 in the forward direction (counterclockwise) such that the contact strip 55a is pushed down while the engagement projections 55b are pushed up.

As shown in FIG. 2, the lid inner member 40 includes a spring support portion 49 formed thereon and positioned between the right and left transverse attachment portions 42. The spring support portion 49 supports the compression spring 52 attached to the right and left retainers 50 thereon. Further, as shown in FIGS. 2, 4 and 5, the lid inner member 40 includes a covering portion 48 configured to cover the hinge cover 30 and the link arm 35 when the lid 3 is attached to the main body 2. As shown in FIG. 4, the covering portion 48 includes right and left recesses 48a respectively arranged so as to be aligned with the engagement pin insertion hole 35f of the link arm 35 and the pin insertion hole 31a of the lower hinge cover 31 in the front-back direction when the lid 3 is attached to the main body 2.

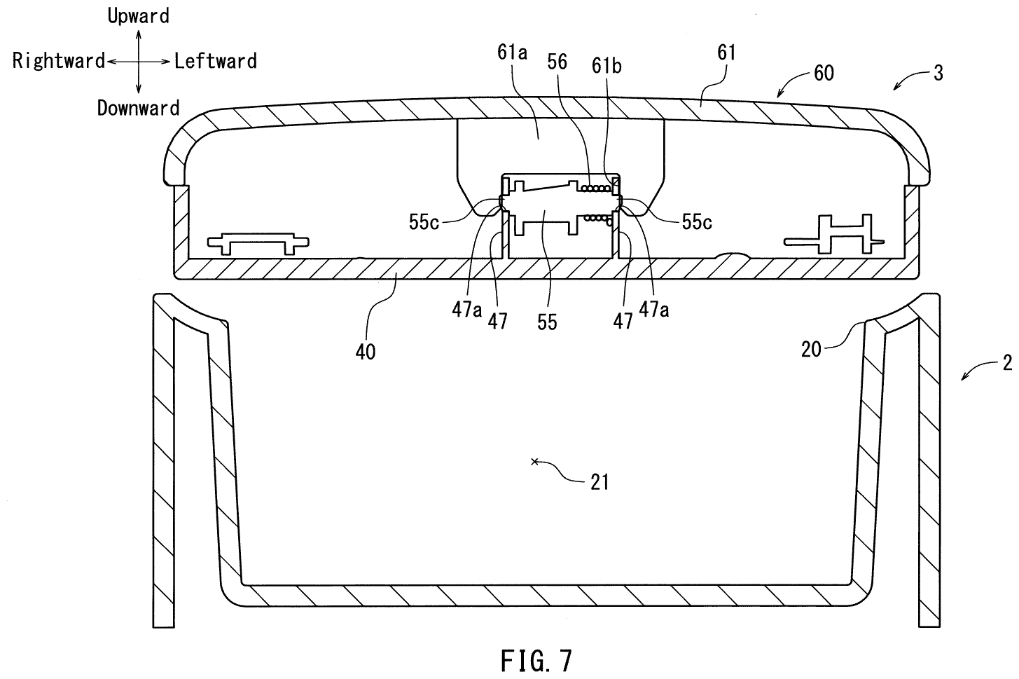

The lid outer member 60 is fitted on the lid inner member 40, thereby forming the lid 3. Further, as shown in FIG. 2, the lid outer member 60 includes a base member 61 and a cover member (not shown) covering the base member 61. As shown in FIGS. 3 and 7, the lid outer member 60 includes a support bracket 61a. The support bracket 61a is formed on an inner surface of the base member 61 and has a U-shaped support surface 61b. The support bracket 61a is configured to clamp the bearing strips 47 with the support surface 61b contacting the bearing strips 47 in a condition in which the lid outer member 60 is fitted on the lid inner member 40. Therefore, in the lid 3, the bearing strips 47 are prevented from being excessively flexed in the direction away from each other.

As shown in FIGS. 4 and 5, the lid 3 is disposed on the main body 2 so as to selectively close the opening 20. In a condition in which the lid is disposed on the main body 2, the hinge pin 53a of the left front link elements 53 is inserted into the left pin insertion hole 24 of the main body 2 while the hinge pin 54a of the left rear elongated link element 54 is inserted into the pin insertion hole 31a of the lower hinge cover 31 through the spring attachment member 35a and the through hole 35b of the link arm 35. In addition, the other end portion 36b of the left torsion spring 36 is hooked on a spring engagement portion (not shown) formed in the lid inner member 40 with the left torsion spring 36 compressed. Thus, the lid inner member 40 (the lid 3) is biased in a leftward rotation direction relative to the link arm 35 by the left torsion spring 36. Similarly, the hinge pin 53a of the right front link elements 53 is inserted into the right pin insertion hole 24 of the main body 2 while the engagement pin 54a of the right rear elongated link element 54 is inserted into the engagement pin insertion hole 35f of the link arm 35. As a result, the lid 3 is connected to the main body 2 via a left hinge device (not labeled) including the left hinge axes (i.e., the hinge pin 53a and the hinge pin 54a) and a right hinge device (not labeled) including the right hinge axes (i.e., the hinge pin 53a and the hinge shaft 35d), so as to be selectively opened and closed in a dual swing-mode. For purposes of clarity and further explanation, the hinge pin 53a, the left pin insertion hole 24, the hinge pin 54a, and the pin insertion hole 31a may also be referred to herein as a left hinge device actuating mechanism 10 for actuating the left hinge device; and the hinge pin 53a, the right pin insertion hole 24, the hinge pin 54a and the engagement pin insertion hole 35f may also be referred to herein as a right hinge device actuating mechanism 11 for actuating the right hinge device. Thus, the lid 3 is attached to the main body 2 (FIG. 1).

As shown by solid line in FIG. 6, in a condition in which the lid 3 is attached to the main body 2 (i.e., in a condition in which the lid 3 closes the opening 20 of the main body 2), which will be referred to as an initial condition of the lid 3, the contact strip 55a of the control member 55 contacts the front wall 23 of the main body 2. As a result, the control member 55 is rotated in the reverse direction (clockwise) against a spring force of the torsion spring 56 such that the contact strip 55a is pushed up while the engagement projections 55b are pushed down.

Further, in the condition in which the lid 3 is attached to the main body 2, the lid 3 is biased by the left torsion spring 36 so as to rotate in a leftward opening direction about the left hinge device. Conversely, the lid 3 is biased by the right torsion spring 37 so as to rotate in a rightward opening direction about the right hinge device along with the link arm 35.

Next, opening and closing operations of the lid 3 will now be described with reference to FIGS. 4 to 6 and 8 to 10.

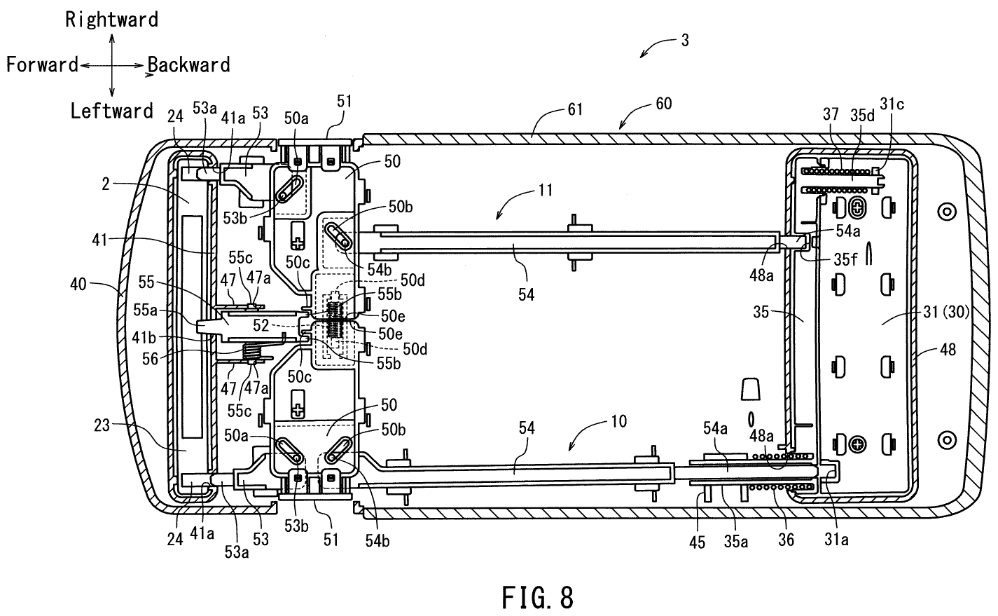

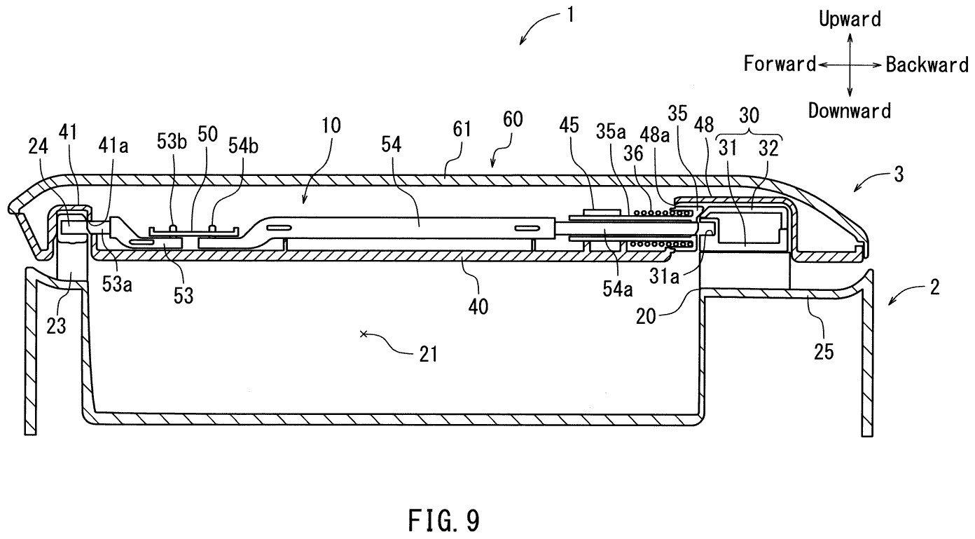

In the initial condition of the lid 3 (FIGS. 1, 4 and 6), both of the right and left hinge device actuating mechanisms 10, 11 are locked such that the right and left hinge devices are actuated. In this condition, in order to open the lid 3 in the rightward opening direction about the right hinge device, the left knob 51 is pressed against a spring force of the compression spring 52 held between spring retainer projections 50d formed on the right and left retainers 50. As a result, as shown in FIGS. 8 and 9, the left retainer 50 integrated with the left knob 51 slides rightward while compressing the compression spring 52. Upon sliding of the left retainer 50, the linking pin 53b of the left front link element 53 moves backward along the front elongated slot 50a, thereby sliding the left front link element 53 backward. As a result, the hinge pin 53a of the left front link element 53 is removed from the left pin insertion hole 24 of the main body 2. Further, as shown in FIG. 8, the left retainer 50 does not interfere with the right retainer 50 when the left knob 51 is pressed.

As shown in FIGS. 8 and 9, at the same time, the linking pin 54b of the left rear link element 54 moves forward along the rear elongated slot 50b, thereby sliding the left rear link element 54 forward. As a result, the hinge pin 54a of the left rear link element 54 is removed from the pin insertion hole 31a of the lower hinge cover 31 and is stored in the spring attachment member 35a of the link arm 35. Consequently, the left hinge device actuating mechanism 10 is unlocked or released, thereby de-actuating the left hinge device. In this condition (i.e., a condition in which the left hinge device actuating mechanism 10 is released), the lid 3 is allowed to rotate about the right hinge device, so as to be opened in the rightward opening direction.

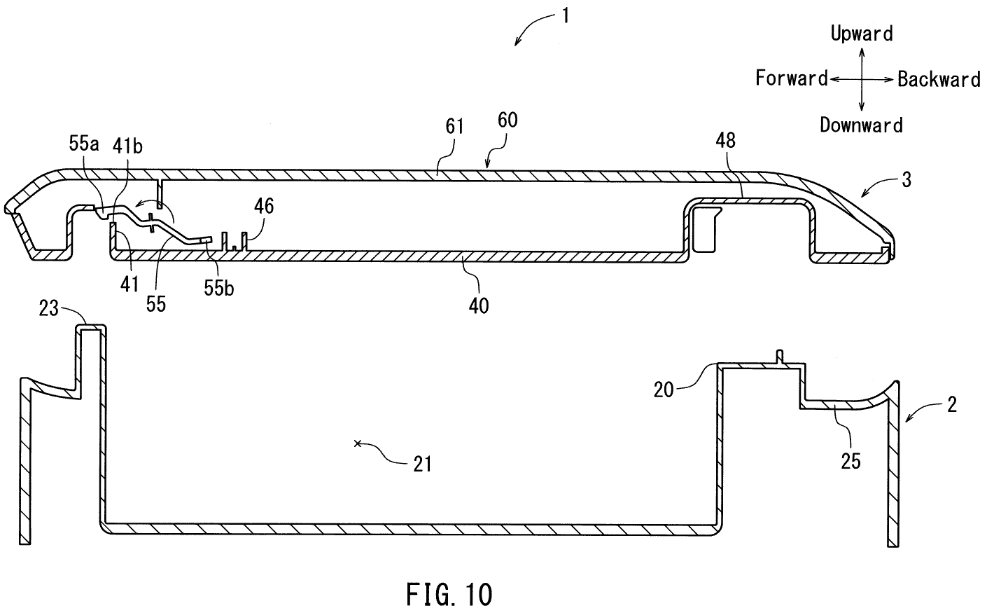

As shown in FIG. 10, when the lid 3 is rotated or opened in the rightward opening direction (which may be referred to as a rightward opened condition of the lid 3), the contact strip 55a of the control member 55 is spaced from the front wall 23 of the main body 2. As a result, the control member 55 is rotated in the forward direction (counterclockwise in FIG. 10) by the spring force of the torsion spring 56 such that the contact strip 55a is pushed down while the engagement projections 55b are pushed up.

Therefore, in the rightward opened condition of the lid 3, when the pressing operation of the left knob 51 is released, the engagement strip 50c of the left retainer 50 contacts or engages the left engagement projection 55b of the control member 55 due to the spring force of the compression spring 52, thereby preventing the left knob 51 (the left retainer 50) from turning back. Thus, even when the pressing operation of the left knob 51 is released in the rightward opened condition of the lid 3, the condition in which the left hinge device actuating mechanism 10 is released is automatically maintained.

Further, when the lid 3 is rotated about the right hinge device in order to open the lid 3 in the rightward opening direction, the link arm 35 rotates about the hinge shaft 35d of the right hinge device in conjunction with the lid 3. As previously described, the link arm 35 is biased in the rightward rotation direction relative to the lower hinge cover 31 by the right torsion spring 37. Therefore, the lid 3 can be easily rotated in the rightward opening direction with the aid of a spring force of the right torsion spring 37.

In a condition in which the left hinge device actuating mechanism 10 is released by pressing the left knob 51 (FIG. 8) and in which the lid 3 is opened in the rightward opening direction, even when the right knob 51 is pressed, the engagement strip 50c of the right retainer 50 contacts or engages the right engagement projection 55b of the control member 55, thereby preventing the right knob 51 from being further pressed. As a result, the right hinge device actuating mechanism 11 is prevented from being released. This means that the right hinge device actuating mechanism 11 cannot be released simultaneously with the left hinge device actuating mechanism 10.

Further, when the left knob 51 is pressed, the end portion 50e of the left retainer 50 moves closer to the end portion 50e of the right retainer 50, so as to be positioned close to the end portion 50e of the right retainer 50. Therefore, in the condition in which the left hinge device actuating mechanism 10 is released by pressing the left knob 51 (FIG. 8) and in which the lid 3 is opened in the rightward opening direction, when the right knob 51 is pressed, the end portion 50e of the right retainer 50 may contact or engage the end portion 50e of the left retainer 50, thereby effectively preventing the right knob 51 from being further pressed. As a result, the right hinge device actuating mechanism 11 is effectively prevented from being released. This contributes to prevention of simultaneous release of the left hinge device actuating mechanism 10 and the right hinge device actuating mechanism 11.

Further, even in a condition in which the left hinge device actuating mechanism 10 is released by pressing the left knob 51 (FIG. 8) and in which the lid 3 is closed, when the right knob 51 is pressed, the end portion 50e of the right retainer 50 may contact or engage the end portion 50e of the left retainer 50, thereby effectively preventing the right knob 51 (the right retainer 50) from being further pressed. That is, the right knob 51 is prevented from being pressed simultaneously with the left knot 51. Therefore, even in such a condition, the right hinge device actuating mechanism 11 is prevented from being released simultaneously with the left hinge device actuating mechanism 10.

When the lid 3 opened in the rightward opening direction is closed, the contact strip 55a of the control member 55 contacts the front wall 23 of the main body 2 so as to be pressed upward (FIG. 6). As a result, the control member 55 is rotated in the reverse direction (clockwise in FIG. 6) against the spring force of the torsion spring 56 such that the contact strip 55a is pushed up while the engagement projections 55b are pushed down. Upon rotation of the control member 55, the engagement strip 50c of the left retainer 50 is disengaged from the left engagement projection 55b of the control member 55. Thus, the control member 55 moves to a position in which the left retainer 50 is allowed to move. As a result, the left knob 51 (the left retainer 50) is automatically turned back due to the spring force of the compression spring 52 (FIG. 4).

Upon turning back of the left retainer 50, the linking pin 53b of the left front link element 53 moves forward along the front elongated slot 50a, thereby sliding the left front link element 53 forward. As a result, the hinge pin 53a of the left front link element 53 engages the left pin insertion hole 24 of the main body 2. At the same time, the linking pin 54b of the left rear link element 54 moves backward along the rear elongated slot 50b, thereby sliding the left rear link element 54 backward. As a result, the hinge pin 54a of the left rear link element 54 projects backward from the spring attachment member 35a of the link arm 35 and engages the pin insertion hole 31a of the lower hinge cover 31. Consequently, the left hinge device actuating mechanism 10 is locked, thereby actuating the left hinge device again. Thus, the lid 3 is restored to the initial condition (FIGS. 1, 4 and 6).

Conversely, in the initial condition of the lid 3, in order to open the lid 3 in the leftward opening direction about the left hinge device, the right knob 51 is pressed against the spring force of the compression spring 52. As a result, the right retainer 50 integrated with the right knob 51 slides leftward while compressing the compression spring 52. Upon sliding of the right retainer 50, the linking pin 53b of the right front link element 53 moves backward along the front elongated slot 50a, thereby sliding the right front link element 53 backward. As a result, the hinge pin 53a of the right front link element 53 is removed from the right pin insertion hole 24 of the main body 2. Further, the right retainer 50 does not interfere with the left retainer 50 when the right knob 51 is pressed.

At the same time, the linking pin 54b of the right rear link element 54 moves forward along the rear elongated slot 50b, thereby sliding the right rear link element 54 forward. As a result, the engagement pin 54a of the right rear link element 54 is removed from the engagement pin insertion hole 35f of the link arm 35. Consequently, the right hinge device actuating mechanism 11 is unlocked or released, thereby de-actuating the right hinge device. In this condition (i.e., a condition in which the right hinge device actuating mechanism 11 is released), the lid 3 is allowed to rotate about the left hinge device, so as to be opened in the leftward opening direction.

As shown in FIG. 10, when the lid 3 is rotated or opened in the leftward opening direction (which may be referred to as a leftward opened condition of the lid 3), the contact strip 55a of the control member 55 is spaced from the front wall 23 of the main body 2. As a result, the control member 55 is rotated in the forward direction (counterclockwise in FIG. 10) by the spring force of the torsion spring 56 such that the contact strip 55a is pushed down while the engagement projections 55b are pushed up.

Therefore, in the leftward opened condition of the lid 3, when the pressing operation of the right knob 51 is released, the engagement strip 50c of the right retainer 50 contacts or engages the right engagement projection 55b of the control member 55 due to the spring force of the compression spring 52, thereby preventing the right knob 51 (the right retainer 50) from turning back. Thus, even when the pressing operation of the right knob 51 is released in the leftward opened condition of the lid 3, the condition in which the right hinge device actuating mechanism 11 is released is automatically maintained.

Further, as previously described, the lid inner member 40 (the lid 3) is biased in the leftward rotation direction by the left torsion spring 36. Therefore, when the lid 3 is rotated about the left hinge device in order to open the lid 3 in the leftward opening direction, the lid 3 can be easily rotated in the leftward opening direction with the aid of a spring force of the left torsion spring 36.

In a condition in which the right hinge device actuating mechanism 11 is released by pressing the right knob 51 and in which the lid 3 is opened in the leftward opening direction, even when the left knob 51 is pressed, the engagement strip 50c of the left retainer 50 contacts or engages the left engagement projection 55b of the control member 55, thereby preventing the left knob 51 from being further pressed. As a result, the left hinge device actuating mechanism 10 is prevented from being released. This means that the left hinge device actuating mechanism 10 cannot be released simultaneously with the right hinge device actuating mechanism 11.

Further, when the right knob 51 is pressed, the end portion 50e of the right retainer 50 moves closer to the end portion 50e of the left retainer 50, so as to be positioned close to the end portion 50e of the left retainer 50. Therefore, in the condition in which the right hinge device actuating mechanism 11 is released by pressing the right knob 51 and in which the lid 3 is opened in the leftward opening direction, when the left knob 51 is pressed, the end portion 50e of the left retainer 50 may contact or engage the end portion 50e of the right retainer 50, thereby effectively preventing the left knob 51 from being further pressed. As a result, the left hinge device actuating mechanism 10 is effectively prevented from being released. This contributes to prevention of simultaneous cancellation of the right hinge device actuating mechanism 11 and the left hinge device actuating mechanism 10.

Further, even in a condition in which the right hinge device actuating mechanism 11 is released by pressing the right knob 51 and in which the lid 3 is closed, when the left knob 51 is pressed, the end portion 50e of the left retainer 50 may contact or engage the end portion 50e of the right retainer 50, thereby effectively preventing the left knob 51 from being further pressed. Therefore, even in such a condition, the left hinge device actuating mechanism 10 is prevented from being released simultaneously with the right hinge device actuating mechanism 11.

When the lid 3 opened in the leftward opening direction is closed, the contact strip 55a of the control member 55 contacts the front wall 23 of the main body 2 so as to be pressed upward (FIG. 6). As a result, the control member 55 is rotated in the reverse direction (clockwise in FIG. 6) against the spring force of the torsion spring 56 such that the contact strip 55a is pushed up while the engagement projections 55b are pushed down. Upon rotation of the control member 55, the engagement strip 50c of the right retainer 50 is disengaged from the right engagement projection 55b of the control member 55. Thus, the control member 55 moves to a position in which the right retainer 50 is allowed to move. As a result, the right knob 51 (the right retainer 50) is automatically turned back due to the spring force of the compression spring 52 (FIG. 4).

Upon turning back of the right retainer 50, the linking pin 53b of the right front link element 53 moves forward along the front elongated slot 50a, thereby sliding the right front link element 53 forward. As a result, the hinge pin 53a of the right front link element 53 engages the right pin insertion hole 24 of the main body 2. At the same time, the linking pin 54b of the right rear link element 54 moves backward along the rear elongated slot 50b, thereby sliding the right rear link element 54 backward. As a result, the engagement pin 54a of the right rear link element 54 engages the engagement pin insertion hole 35f of the link arm 35. Consequently, the right hinge device actuating mechanism 11 is locked, thereby actuating the right hinge device again. Thus, the lid 3 is restored to the initial condition (FIGS. 1, 4 and 6).

According to the console box 1, in a condition in which the lid 3 is closed, when one of the right and left knobs 51 is pressed, one of the right and left retainers 50 is positioned close to the other of the right and left retainers 50. Therefore, in a condition in which one of the right and left knobs 51 is pressed, the other of the right and left knobs 51 is prevented from being pressed. That is, the right and left knobs 51 are prevented from being simultaneously pressed. As a result, the right and left hinge device actuating mechanisms 10, 11 are prevented from being simultaneously released. In addition, when one of the right and left knobs 51 is pressed, one of the right and left knobs 51 does not interfere with the other of the right and left knobs 51 that is not pressed. As a result, each of the right and left knobs 51 can be smoothly pressed. Further, in a condition in which one of the right and left hinge device actuating mechanisms 10, 11 is released by pressing one of the right and left knobs 51 and in which the lid 3 is opened, the engagement strip 50c of one of the right and left retainers 50 engages one of the right and left engagement projections 55b of the control member 55 due to the spring force of the compression spring 52, thereby preventing one of the right and left knobs 51 (one of the right and left retainers 50) from turning back. Therefore, even when the pressing operation of one of the right and left knobs 51 is released, the condition in which one of the right and left hinge device actuating mechanisms 10, 11 is released is automatically kept. Further, each of the right and left release devices (the right and left knobs 51 and the right and left retainers 50) is simplified in structure. Therefore, the number of parts is substantially reduced.

Various changes and modifications may be made to the present embodiment without departing from the scope of the disclosure. For example, in the embodiment, the bearing strips 47 are formed on the lid inner member 40 while the support bracket 61a is formed on the base member 61 of the lid outer member 60. However, the bearing strips 47 may be formed on the base member 61 of the lid outer member 60 while the support bracket 61a may be formed on the lid inner member 40.

A representative example of the present disclosure has been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detailed description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A console box, comprising:
a main body having an opening; and
a lid coupled to the main body via a left hinge device and a right hinge device, wherein the lid is configured to open and close the opening in a dual swing-mode,
wherein the lid includes a left hinge device actuating mechanism configured to actuate the left hinge device, a right hinge device actuating mechanism configured to actuate the right hinge device, a left release device coupled to the left hinge device actuating mechanism and configured to release the left hinge device actuating mechanism by pressing, a right release device coupled to the right hinge device actuating mechanism and configured to release the right hinge device actuating mechanism by pressing, and a control member configured to selectively control a movement of each of the right and left release devices,
wherein the right release device and the left release device are disposed on the lid with a space therebetween,
wherein the right release device and the left release device are configured such that when one of the right release device and the left release device is pressed, one of the right release device and the left release device is positioned close to the other of the right release device and the left release device,
wherein the control member is configured such that with the lid positioned to close the opening of the main body, the control member moves to a position configured to allow the right release device and the left release device to move relative to each other, and
wherein the control member is configured such that with the lid positioned to open the opening of the main body after one of the right release device and the left release device is pressed, the control member moves to a position in which the control member engages one of the right release device and the left release device to prevent the right release device and the left release device from moving relative to each other.

2. The console box of claim 1, wherein the lid includes a lid inner member and a lid outer member,
wherein one of the lid inner member and the lid outer member includes a pair of bearing strips while the other of the lid inner member and the lid outer member includes a support bracket,
wherein the control member is attached to the bearing strips, and
wherein the support bracket is configured to clamp the bearing strips.
